(19) United States
(12) Patent Application Publication
(10) Pub. No.: US 2022/0343801 A1
(43) Pub. Date: Oct. 27, 2022

(54) VEHICLE IDENTIFICATION KEYCHAIN TAG APPARATUS

(71) Applicant: Edward Wichmann, Lee's Summit, MO (US)

(72) Inventor: Edward Wichmann, Lee's Summit, MO (US)

(21) Appl. No.: 17/241,534

(22) Filed: Apr. 27, 2021

(51) Int. Cl. G09F 3/02

(52) U.S. Cl. CPC G09F 3/02; G09F 2003/0208; G09F 2003/0255

(57) ABSTRACT

A vehicle identification keychain tag apparatus for tagging keys with full vehicle details includes a tag body having a tag front side, a tag back side, a tag top edge, a tag bottom edge, a tag left edge, and a tag right edge. The tag body has at least one keychain aperture extending from the tag front side through the tag back side to selectively engage a keychain. A plurality of information fields is coupled to the tag front side and defines areas to receive written vehicle information. A protector is coupled to the tag body. The protector is foldably coupled to the tag right edge and has an adhesive protector inner face. The protector inner face is adhered to the tag front side once the plurality of information fields has been filled. A backing is coupled to the protector and is selectively engageable with the protector inner face.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle identification tag devices and more particularly pertains to a new vehicle identification tag device for tagging keys with full vehicle details. The present device includes a tag with a vertical vehicle identification number (VIN) field. There is an attached adhesive clear plastic protector to fold over the information fields once filled to prevent smudging.

### (2) Description of Related Art Including Information Disclosed Under 37 CFR 1.97 and 1.98

The prior art relates to vehicle identification tag devices. Known devices include information fields that are often not large enough to accommodate the VIN. These devices lack a plastic adhesive protector to cover written information.

### BRIEF SUMMARY OF THE INVENTION

An embodiment of the disclosure meets the needs presented above by generally comprising a tag body having a tag front side, a tag back side, a tag top edge, a tag bottom edge, a tag left edge, and a tag right edge. The tag body has at least one keychain aperture extending from the tag front side through the tag back side. The keychain aperture is configured to selectively engage a keychain. A plurality of information fields is coupled to the tag body. The plurality of information fields is coupled to the tag front side and defines areas to receive written vehicle information. A protector is coupled to the tag body. The protector is foldably coupled to the tag right edge and has an adhesive protector inner face. The protector inner face is adhered to the tag front side once the plurality of information fields has been filled. A backing is coupled to the protector. The backing is selectively engageable with the protector inner face.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front elevation view of a vehicle identification keychain tag apparatus according to an embodiment of the disclosure.

FIG. 2 is a rear elevation view of an embodiment of the disclosure.

FIG. 3 is an isometric view of an embodiment of the disclosure.

FIG. 4 is an isometric view of an embodiment of the disclosure.

FIG. 5 is an isometric view of an embodiment of the disclosure.

FIG. 6 is a flow chart of an embodiment of the disclosure.

### DETAILED DESCRIPTION OF THE INVENTION

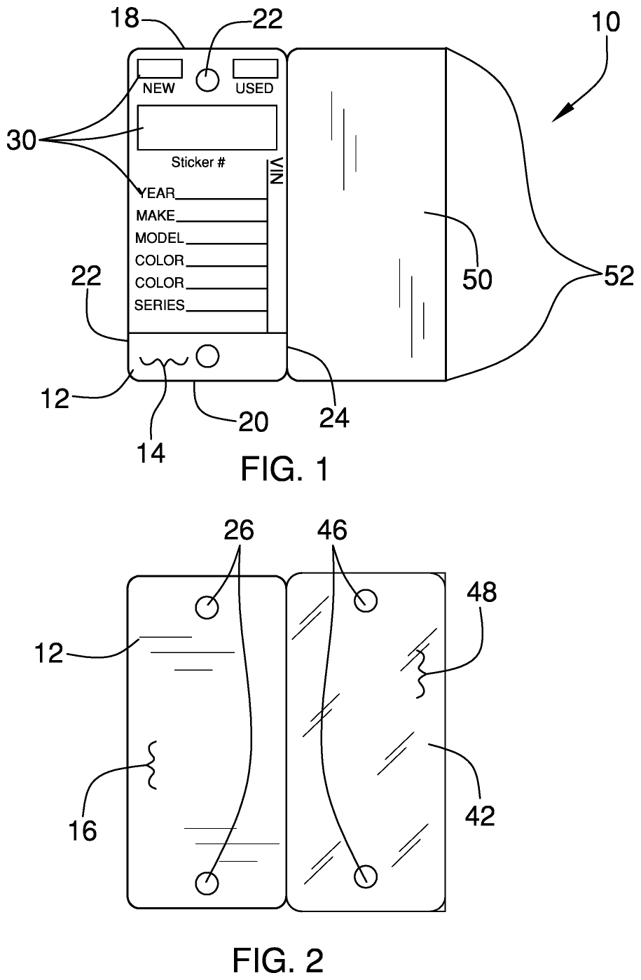

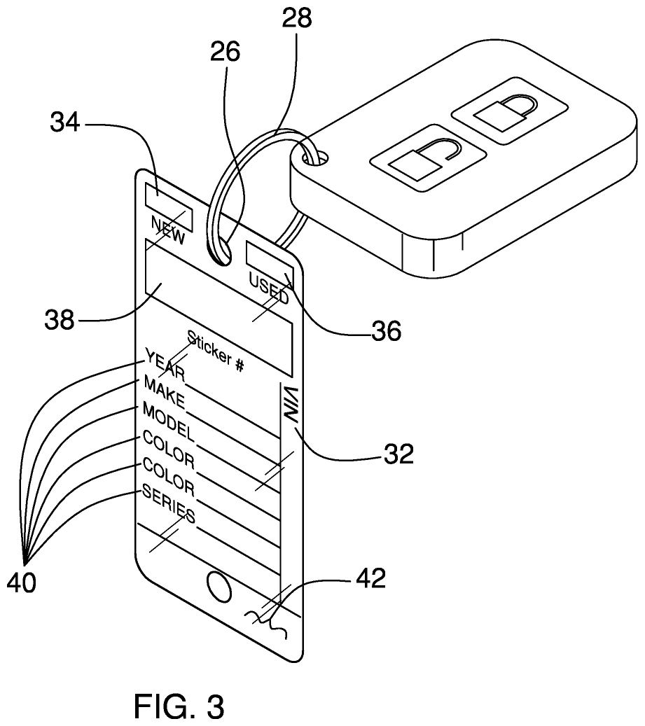

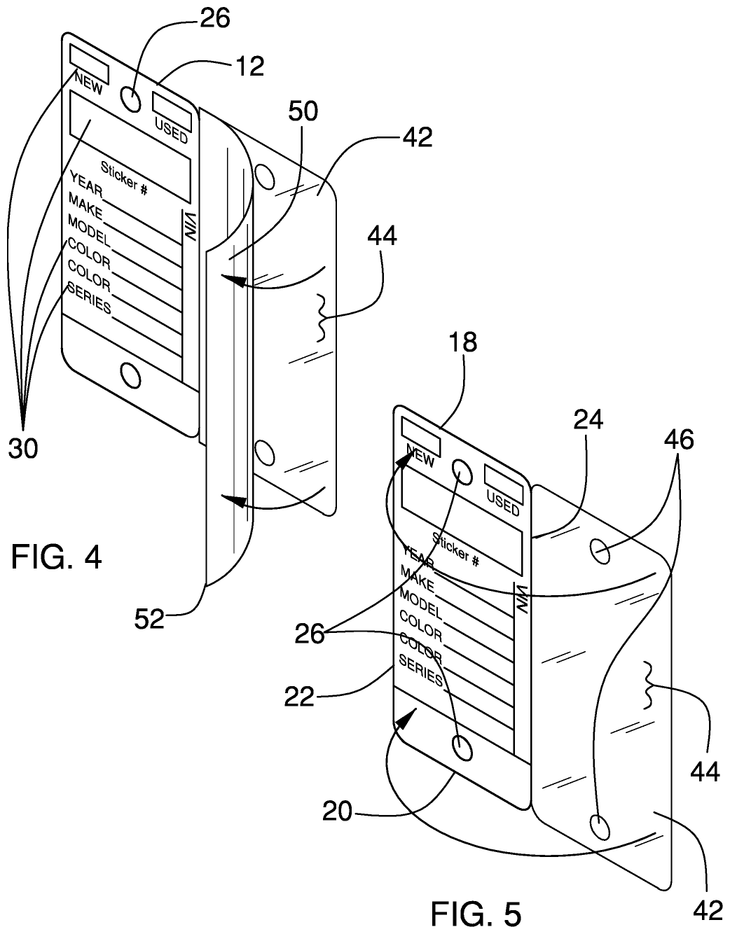

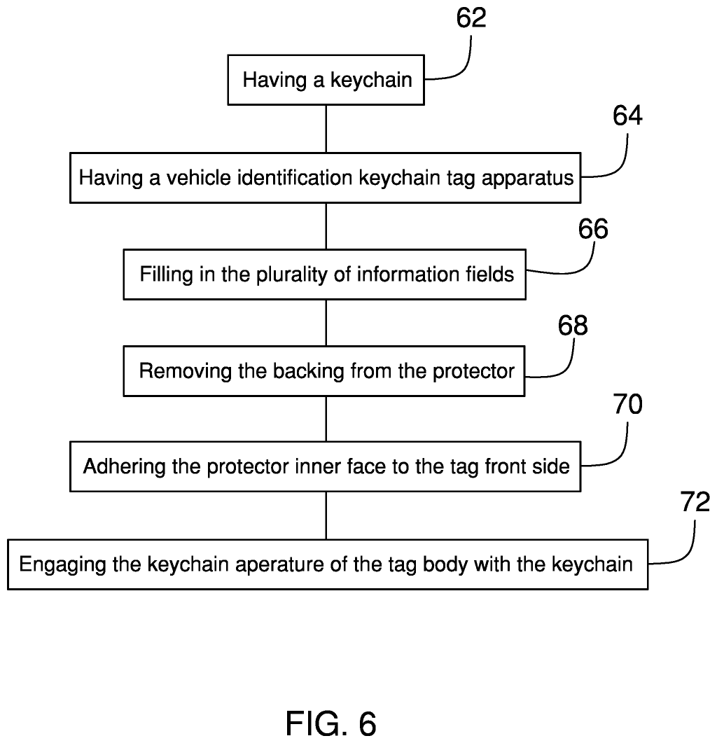

With reference now to the drawings, and in particular to FIGS. 1 through 6 thereof, a new vehicle identification tag device embodying the principles and concepts of an embodiment of the disclosure and generally designated by the reference numeral 10 will be described.

As best illustrated in FIGS. 1 through 6, the vehicle identification keychain tag apparatus 10 generally comprises a tag body 12 having a tag front side 14, a tag back side 16, a tag top edge 18, a tag bottom edge 20, a tag left edge 22, and a tag right edge 24. The tag body 12 has at least one keychain aperture 26 extending from the tag front side 14 through the tag back side 16. The keychain aperture 26 may be a pair of keychain apertures 26 proximal the tag top edge 18 and the tag bottom edge 20. Each keychain aperture 26 is configured to selectively engage a keychain 28.

A plurality of information fields 30 is coupled to the tag body 12. The plurality of information fields 30 is coupled to the tag front side 14 and defines areas to receive written vehicle information. The plurality of information fields 30 may include a vehicle identification number (VIN) field 32. The VIN field 32 may be oriented vertically adjacent the tag right edge 24. The plurality of information fields 30 may also include a new box 34, a used box 36, a sticker number box 38, and a plurality of descriptor fields 40 for the year, make, model, color, and series.

A transparent protector 42 is coupled to the tag body 12. The protector 42 is foldably coupled to the tag right edge 24 and has an adhesive protector inner face 44. The protector inner face 44 is adhered to the tag front side 14 once the plurality of information fields 30 has been filled. Each of the tag body 12 and the protector 42 may have rounded corners and the same dimensions. The protector 42 has a pair of protector apertures 46 extending from the protector inner face 44 through a protector outer face 48. The pair of protector apertures 46 aligning with the pair of keychain apertures 26 when the protector inner face 44 is adhered to the tag front side 14.

A backing 50 coupled to the protector 42. The backing 50 is selectively engageable with the protector inner face 44 to prevent inadvertent adhesion before use. The backing 50 may have a pair of squared outer backing corners 52 extending past the protector 42 to easily be peeled off when desired.

In use, the vehicle identification keychain tag apparatus 10 allows for a method of use 60 comprising a step 62 comprising having a keychain. A step 64 comprises vehicle identification keychain tag apparatus 10. A step 66 comprises filling in the plurality of information fields 30. A step 68 comprises removing the backing 50 from the protector 42. A step 70 comprises adhering the protector inner face 46 to the tag front side 14. A step 72 comprises engaging the keychain aperture 26 of the tag body with the keychain 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle identification keychain tag apparatus comprising:
a tag body having a tag front side, a tag back side, a tag top edge, a tag bottom edge, a tag left edge, and a tag right edge, the tag body having at least one keychain aperture extending from the tag front side through the tag back side, the keychain aperture being configured to selectively engage a keychain;
a plurality of information fields coupled to the tag body, the plurality of information fields being coupled to the tag front side and defining areas to receive written vehicle information;
a protector coupled to the tag body, the protector being foldably coupled to the tag right edge and having an adhesive protector inner face, the protector inner face being adhered to the tag front side once the plurality of information fields has been filled; and
a backing coupled to the protector, the backing being selectively engageable with the protector inner face.

2. The vehicle identification keychain tag apparatus of claim 1 further comprising the plurality of information fields including a vehicle identification number (VIN) field, the VIN field being oriented vertically adjacent the tag right edge.

3. The vehicle identification keychain tag apparatus of claim 1 further comprising each of the tag body and the protector having rounded corners.

4. The vehicle identification keychain tag apparatus of claim 3 further comprising the backing having a pair of squared outer backing corners extending past the protector.

5. The vehicle identification keychain tag apparatus of claim 1 further comprising the keychain aperture of the tag body being a pair of keychain apertures proximal the tag top edge and the tag bottom edge.

6. The vehicle identification keychain tag apparatus of claim 5 further comprising the protector having a pair of protector apertures extending from the protector inner face through a protector outer face, the pair of protector apertures aligning with the pair of keychain apertures when the protector inner face is adhered to the tag front side.

7. A vehicle identification keychain tag apparatus comprising:
a tag body having a tag front side, a tag back side, a tag top edge, a tag bottom edge, a tag left edge, and a tag right edge, the tag body having at least one keychain aperture extending from the tag front side through the tag back side, the keychain aperture being a pair of keychain apertures proximal the tag top edge and the tag bottom edge, each keychain aperture being configured to selectively engage a keychain;
a plurality of information fields coupled to the tag body, the plurality of information fields being coupled to the tag front side and defining areas to receive written vehicle information, the plurality of information fields including a vehicle identification number (VIN) field, the VIN field being oriented vertically adjacent the tag right edge;
a protector coupled to the tag body, the protector being foldably coupled to the tag right edge and having an adhesive protector inner face, the protector inner face being adhered to the tag front side once the plurality of information fields has been filled, each of the tag body and the protector having rounded corners, the protector having a pair of protector apertures extending from the protector inner face through a protector outer face, the pair of protector apertures aligning with the pair of keychain apertures when the protector inner face is adhered to the tag front side; and
a backing coupled to the protector, the backing being selectively engageable with the protector inner face, the backing having a pair of squared outer backing corners extending past the protector.

8. A method of adding vehicle identifying information to a keychain comprising:
having a keychain;
having a vehicle identification keychain tag apparatus comprising:
a tag body having a tag front side, a tag back side, a tag top edge, a tag bottom edge, a tag left edge, and a tag right edge, the tag body having at least one keychain aperture extending from the tag front side through the tag back side, the keychain aperture being configured to selectively engage the keychain;
a plurality of information fields coupled to the tag body, the plurality of information fields being coupled to the tag front side and defining areas to receive written vehicle information;
a protector coupled to the tag body, the protector being foldably coupled to the tag right edge and having an adhesive protector inner face, the protector inner face being adhered to the tag front side once the plurality of information fields has been filled; and
a backing coupled to the protector, the backing being selectively engageable with the protector inner face;
filling in the plurality of information fields;
removing the backing from the protector;
adhering the protector inner face to the tag front side; and
engaging the keychain aperture of the tag body with the keychain.
